(19) United States
(12) Patent Application Publication
(10) Pub. No.: US 2004/0178141 A1
(43) Pub. Date: Sep. 16, 2004

(54) Composite solid material fixing mineral pollutants, method for preaparing same and method for fixing pollutants using same

(76) Inventors: Claire Vidal-Madjar, Paris (FR); Marie-Claude Millot, Paris (FR); Isabelle Bispo, Paris (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/486,834

(22) PCT Filed: Aug. 20, 2002
(86) PCT No.: PCT/FR02/02905

(30) Foreign Application Priority Data
Aug. 22, 2001 (FR) 01/11004

(51) Int. Cl. B01D 39/00

(52) U.S. Cl. 210/490; 210/483; 210/488; 210/489; 210/504

(57) ABSTRACT

The invention relates to a composite solid material which fixes inorganic contaminants based on metal hexacyanoferrate comprising a solid support coated with a thin film of an anion-exchange polymer to which is fixed an insoluble metal hexacyanoferrate forming a thin layer, characterized in that said polymer is a noncrosslinked polymer which comprises, as anion-exchange groups, solely quaternary ammonium groups and in that it does not comprise primary, secondary or tertiary amine groups.

The present invention also relates to the process for the preparation of said composite solid material which fixes inorganic contaminants based on hexacyanoferrates.

Finally, the present invention relates to a process, which can be carried out on a column and continuously, for fixing at least one inorganic contaminant present in a solution to said composite solid material which fixes inorganic contaminants.

Said solution is in particular a liquid or an effluent resulting from the nuclear industry and from nuclear plants.

### DESCRIPTION

The present invention relates to a composite solid material fixing inorganic contaminants, based on hexacyanoferrates and on cationic polymer, deposited as a layer of a thin film on a support.

More specifically, the present invention relates to a composite solid material which fixes inorganic contaminants formed of a mechanically and chemically stable solid support coated with a film of a specific anion-exchange polymer, namely a polycation carrying quaternary ammonium groups, to which is fixed a thin layer of insoluble hexacyanoferrate.

The present invention also relates to the process for the preparation of said composite solid material fixing inorganic contaminants based on hexacyanoferrates.

Finally, the present invention relates to a process for fixing at least one inorganic contaminant present in a solution, on said composite solid material which fixes inorganic contaminants.

Numerous inorganic fixing agents have been used for fixing various inorganic contaminants, such as metal cations, present in various media and effluents resulting from various industries and in particular from the nuclear industry.

This is because the nuclear industry uses, for the treatment of slightly or moderately radioactive effluents, purification techniques with reduction in volume consisting of the fixing to an inorganic solid of the radioisotopes present in the solutions. The volumes currently treated are huge and reach several tens of thousands of m³/year for France. The liquids treated are also varied in nature since the treatment concerned is equally well that of the cooling waters from nuclear power stations as that of the various effluents coming into contact with radioisotopes, such as all aqueous washing solutions, solutions from the regeneration of resins, and the like.

Hexacyanoferrates, in particular Cu hexacyanoferrate(II), Ni hexacyanoferrate(II) and Co hexacyanoferrate(II), are among the most commonly used inorganic fixing agents, in particular in the nuclear industry, because of the high affinity which they have with regard to caesium. Inorganic fixing agents of hexacyanoferrate type have therefore been employed in particular for separating, recovering and fixing metal ions and in particular radioactive alkali metal ions, such as caesium-137, with a long half life from various industrial and nuclear effluents, for example from the highly acidic solutions resulting from the reprocessing of irradiated fuels and from the solutions already mentioned above.

Currently, insoluble hexacyanoferrates thus participate in the majority of processes for the treatment of liquid radioactive waste by coprecipitation.

The document FR-A-2 765 812 discloses the method of preparation and of use in a column of a material composed of metal hexacyanoferrate fixed to a chemically and mechanically stable solid support coated with a film of anion-exchange organic polymers for the fixing of at least one inorganic contaminant resulting in particular from a liquid or from an effluent from the nuclear industry. The product, first of all prepared and then packed in the form of a column, makes possible the complete and irreversible fixing of caesium-137.

In this material, the hexacyanoferrate anion is adsorbed on the anion-exchange polymer covering a solid support in the form of a thin film by interactions of electrostatic type and, for this reason, adheres strongly to the support. This bonding involves phenomena of adsorption in the pores as in impregnated hexacyanoferrates. The deposition of the hexacyanoferrate is carried out uniformly over the entire modified surface of the support. All the possible exchange sites of the polymer are exchanged; the composition and the properties of the material are perfectly controlled and reproducible, in contrast to the materials of the art prior to this document. Residual hexacyanoferrates capable of being released and subsequently disrupting the fixing process are no longer present at the surface of the material.

The material exhibits a contact surface area of the same order of magnitude as the specific surface of the support selected; the reactivity of the copper hexacyanoferrate is thus increased.

The coefficient of distribution of caesium is high (Kd>100 000) and comparable with those of impregnated hexacyanoferrates with amounts of hexacyanoferrate of 1 to 2% by weight with respect to the weight of support. This is in particular the reason why it is possible to readily store the material of this document, which is stable and essentially inorganic.

The anion-exchange polymer composing the material of the document FR-A-2 765 812 is described in a very general way as being an organic polymer devoid of cationic groups.

According to this document, the organic polymer is preferably chosen from polyvinylimidazoles, copolymers of vinylimidazole with at least one other monomer, polyethyleneimines, polyamines and any polymer carrying a cationic group. This cationic group can be chosen in particular from ammonium, phosphonium or sulphonium groups. The polymer used in the examples is a crosslinked and quaternized polyvinylimidazole and a crosslinked polyethyleneimine.

It is known that the choice of polymer carrying cationic groups forming the first layer adsorbed on the solid support, which is, for example, porous, is essential in the synthesis of the composite material.

In the document FR-A-2 765 812, it is explained that any anion-exchange polymer is suitable for these purposes, provided that a very adherent film or thin film is formed at the surface of the support. In the abovementioned patent, in order to obtain good adherence, good hold of the polymer to the support and a stable film on this same support, it is in the majority of cases necessary to crosslink the polymer by covalent bonding to said support. For the polymer, crosslinking is not generally necessary. Crosslinking is indispensable in particular in order to obtain a stable film which adheres to the support, such as silica, with polymers such as polyethyleneimines (PEI) and polyvinylimidazoles (PVI). In point of fact, these stages of crosslinking and/or of fixing by covalent bonding or grafting in order to immobilize the polymer, for example PEI, on the support are lengthy and difficult. This is because these stages are carried out under batchwise conditions in an organic medium with reaction times ranging up to 48 hours and require drying of the support beforehand under vacuum.

Furthermore, it was also observed that, during the stage of formation of the insoluble metal hexacyanoferrate, for example copper hexacyanoferrate, described in FR-A-2 765 812, the metal ions could form unstable complexes with the groups of the polymer. Thus, during the stage of the formation of copper hexacyanoferrate, it was observed that the metal ions, for example copper ions, in solution could become fixed in the form of complexes to the primary, secondary and tertiary amine groups of the polymer film, for example PEI or PVI film, to thus give unstable complexes.

When metal ions, such as cupric ions, are complexed by the polymer, problems of subsequent release of these ions from the composite solid material were observed, requiring lengthy stages of washing after contact of the support with the metal salt, such as copper nitrate.

There thus exists a need for a composite solid material which fixes contaminants which, in comparison with the composite solid material of the prior art, as represented essentially by the document FR-A-2 765 812, does not comprise unstable metal complexes which bring about phenomena of release, which can be prepared by a simplified and reliable process comprising a reduced number of stages, which exhibits perfectly controlled and stable properties devoid of random variation, and in which in particular the polymer is attached in a highly adherent and very stable way to the support without resorting to complicated and lengthy grafting and/or crosslinking operations.

It is very clear that this material must also meet the criteria and requirements which are for the most part already met by the solid composite material of the prior art represented by FR-A-2 765 812.

In particular, this material must be chemically and mechanically stable in order to be able to be thus packed in a column allowing continuous operation.

The solid composite material which fixes inorganic contaminants must also have excellent fixing properties, in particular decontaminating properties, that is to say analogous to, indeed even better than, in particular those of hexacyanoferrates not impregnated on a support.

The solid material which fixes inorganic contaminants must also combine good mechanical stability with a high reaction rate, in contrast to the products in the compact form, the low specific surface of which results in slow reaction rates.

In other words, the solid material which fixes inorganic contaminants based on metal hexacyanoferrates must exhibit, inter alia, excellent mechanical and chemical stabilities, a high coefficient of affinity or of decontamination, high reactivity and good selectivity.

These properties must be obtained with a minimum amount of inorganic fixing agent of metal hexacyanoferrate type.

Furthermore, in particular in the case of the fixing of radioactive elements, it is necessary for the composite solid material which fixes inorganic contaminants to be able to be easily stored and/or vitrified without risk by known processes.

Finally, the material must exhibit a composition and properties which are perfectly reproducible and controlled and must be prepared by a reliable process.

One aim of the present invention is therefore to provide a composite solid material which fixes inorganic contaminants based on metal hexacyanoferrates which does not exhibit the disadvantages, faults, draw-backs and limitations of the composite solid materials fixing inorganic contaminants of the prior art, as represented essentially by the document FR-A-2 765 812, which overcomes the problems of the materials of the prior art and which meets, inter alia, all the requirements mentioned above.

This aim, and yet others, are achieved in accordance with the invention by a composite solid material fixing inorganic contaminants, based on metal hexacyanoferrate, comprising a solid support coated with a film of an anion-exchange polymer to which is fixed an insoluble metal hexacyanoferrate forming a thin layer, characterized in that said polymer is a noncrosslinked polymer, which comprises, as anion-exchange groups, solely quaternary ammonium groups and in that it does not comprise primary, secondary or tertiary amine groups.

Preferably, said anion-exchange cationic polymer is a polybrene® (trademark registered by Abbot Laboratories) or hexadimethrine bromide or poly-(N,N,N′,N′-tetramethyltrimethylenehexamethylenediammonium dibromide) (C₁₃H₃₀Br₂N₂)ₓ, CAS No. [2 8728-55-4], which is a water-soluble polymer widely used in biochemical applications and which comprises solely quaternary ammonium groups.

The formula of polybrene® is as follows:

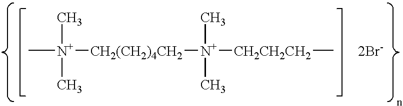

The material according to the invention differs fundamentally from the materials of the prior art and in particular from those disclosed in the document FR-A-2 765 812.

This is because, according to the invention, the selection is made from a specific restricted family of polymers among the numerous cationic polymers existing and mentioned in the abovementioned document. This restricted family of polymers is specifically defined according to the invention in that these polymers comprise, as anion-exchange groups, solely quaternary ammonium groups, in that they do not comprise primary, secondary and tertiary amine groups and, finally, in that they are not crosslinked.

Surprisingly, these specific polymers make it possible to solve the problems posed by the materials of the prior art, in particular of the document FR-A-2 765 812, and greatly improve the properties of the composite materials of the prior art.

The materials according to the invention do not exhibit the disadvantages, limitations, faults and drawbacks of the materials of the above-mentioned document and meet the criteria, i.e. requirements, listed above. The specific polymer used according to the invention exhibits excellent adherence to the support, such as silica, without requiring any crosslinking.

The polymer adheres to the support in an excellent way, without crosslinking or fixing by covalent bonding. For the subsequent syntheses, this adhesion is sufficient to fix and precipitate the metal hexacyanoferrate. Owing to the fact that it does not comprise primary, secondary and tertiary groups, the formation of unstable metal complexes is avoided, as is the subsequent release of metal ions, such as copper, from the material.

For this reason, the properties of the composite material are perfectly controlled and stable and do not undergo random variations.

The thin film is highly adherent to the support and this thin film is extremely stable. It may be thought that the excellent adherence of the polymer, such as polybrene®, to the support originates from the interaction between the NR₄⁺ groups of the polymer and the silanol groups of the support.

The use in the material according to the invention of the specific polymers described above also advantageously affects the process for the preparation of the material, as is described in detail later.

In particular, the use of cationic polymers comprising solely quaternary ammonium groups which are soluble in water makes it possible to adsorb the polymer in an aqueous medium, without preliminary drying of the support, with a reduced contact time, to dispense with the crosslinking stage carried out at 60° C. and to avoid the formation of complexes with metals, such as copper, in solution during the stage of precipitation of the insoluble metal, such as copper, hexacyanoferrate; this is not the case with the polymers of the prior art, such as PEI and PVI, where the formation of unstable complexes is observed.

This is because the polymer used according to the invention does not comprise primary and secondary amine groups, which prevents the formation of complexes with a metal ion, such as the copper ion. The final washing stages are greatly reduced.

The material according to the invention exhibits a specific structure in which the inorganic fixing agent as such, that is to say the metal hexacyanoferrate, exists in the form of a thin layer which is immobilized on a polymer phase fixed to a support, said support being solid and advantageously chemically and mechanically stable and being protected and isolated from the action of the medium by the underlying polymer layer.

For this-reason, the material according to the invention is also chemically and mechanically stable and combines these stabilities with a high rate of reaction, and is perfectly suited to packing in a column.

By way of example, the material according to the invention proved to be perfectly stable mechanically on a column after washing with pure water for several days, corresponding to more than 10 000 column volumes.

In the material according to the invention, the hexacyanoferrate anion is adsorbed on the polymer via interactions of electrostatic type and, for this reason, adhere strongly to the support.

The bond which exists between the anionic part of the metal hexacyanoferrate and the support coated with the anion-exchange polymer is a bond of electrostatic type which is not a weak bond of mechanical nature involving essentially phenomena of adsorption in the pores, as is the case in impregnated hexacyanoferrates, for example impregnated on a silica gel.

The hexacyanoferrate is deposited uniformly over the entire modified surface of the support.

All the possible exchange sites of the anion-exchange polymer are exchanged; the composition and the properties of the material according to the invention are therefore perfectly controlled and reproducible, in contrast to the materials of the prior art.

As, in addition, all the sites of the anion-exchange polymer which is used in the invention are quaternary ammonium sites which give a stable bond and as there exists no other site of the primary, secondary and tertiary amine type which gives unstable complexes, excess metal, for example residual copper, capable of being released and subsequently disturbing the fixing process is no longer present at the surface of the material.

The material according to the invention more-over exhibits a contact surface area which is of the same order of magnitude as the specific surface of the support chosen. Consequently, the reactivity of the hexacyanoferrate is increased with respect to the prior art.

The coefficient of distribution of the material according to the invention, which is preferably from 10 000 to 100 000 for one gram of material, is raised and is comparable to that of the bulk hexacyanoferrates but the amounts of hexacyanoferrates employed are advantageously much lower than those of the hexacyanoferrates impregnated on silica of the prior art.

Thus, the material according to the invention generally comprises an amount of fixed metal hexacyanoferrate of 1 to 10% by weight, preferably of 2 to 3% by weight, with respect to the weight of the support; this value is to be compared with the value of 30% for the hexacyanoferrates impregnated on silica of the prior art cited above.

The amount of ferrocyanide which is fixed and discharged after it has been used is limited and the same effectiveness is obtained for an amount of hexacyanoferrate, for example, which is ten times less, as all the product fixed is effective.

This is in particular the reason why it is possible to readily store the material according to the invention, which is stable and essentially inorganic, and/or to vitrify it, which was until now impossible with the materials of the prior art.

More specifically, the solid support can be chosen from the supports known to a person skilled in the art and which are suitable for the use described; these solid supports can be organic or inorganic and are generally chosen from chemically and mechanically stable solid supports.

The support will thus preferably be chosen from inorganic oxides, such as silica, alumina, titanium oxide, zirconium oxide, diatomaceous earth, glasses and zeolites; a preferred support is silica, readily available at a reasonable cost.

The support can be provided in any form, for example in the form of particles, such as grains, beads or spheres, in the form of fibres, or other forms, or in the form of a membrane, of a hollow tube, of a woven or nonwoven fabric, and the like.

The particle size of the support in the form of particles, defined by the size of the particles, that is to say the diameter in the case of spherical particles, can vary within wide limits and will generally be from 1 to 500 μm, preferably greater than or equal to 10 μm, more preferably greater than or equal to 30 μm, for example in the tests in columns.

The specific surface of the support can also be variable, for example from 10 to 500 m²/g, preferably 30 to 500 m²/g.

The support is preferably a porous support, in order to make possible better fixing of the polymer.

The mean size of the pores of the support is variable and is preferably from 100 to 1 000 Å.

The anion-exchange polymer of the composite solid material which fixes inorganic contaminants according to the invention is an organic polymer provided with cationic groups; as all these anion-exchange cationic groups are quaternary ammonium groups, these quaternary ammonium groups are, for example, NR₄⁻ groups.

In addition, and this is fundamental, the specific polymer of the invention does not comprise primary or secondary amine groups which give unstable complexes with metal ions, such as the copper ion.

This organic polymer is preferably chosen from the polymers known under the name of polybrene®, the formula of which has already been given above.

The specific polymer used, such as polybrene® forms a highly adherent film or thin film at the surface of the support by adsorption on the support, without it being necessary to fix by covalent bonding and/or to crosslink. These stages are consequently dispensed with in the process.

The metal hexacyanoferrate which is fixed to the anion-exchange polymer can be any hexacyanoferrate known to a person skilled in the art; it can be chosen, for example, from copper, cobalt, zinc, cadmium, nickel and iron hexacyanoferrates and the mixed hexacyanoferrates relating to these salts.

The invention also relates to a process for the preparation of the composite solid material which fixes inorganic contaminants based on hexacyanoferrates described above, this process being characterized in that it comprises the following stages:

impregnation of a solid support with an aqueous solution of a noncrosslinked anion-exchange polymer comprising, as anion-exchange groups, solely quaternary ammonium groups and not comprising primary, secondary and tertiary amine groups, in order to form a film of said polymer on said solid support;

washing with demineralized water, and optionally drying under vacuum;

impregnation of the solid support thus coated with a thin film of anion-exchange polymer with an aqueous solution of alkali metal hexacyanoferrate;

washing with demineralized water, and optionally drying under vacuum, said solid support coated with a thin film of anion-exchange polymer to which is fixed an alkali metal hexacyanoferrate;

addition of an aqueous solution of a metal salt to said coated solid support, in order to form a composite solid material which fixes inorganic contaminants comprising the solid support coated with a film of anion-exchange polymer to which is fixed an insoluble metal hexacyanoferrate forming a thin layer;

washing with demineralized water and optionally drying under vacuum.

In comparison with the process of the prior art, as described in the document FR-A-2 765 812, which employs nonspecific cationic polymers, the process according to the invention, by virtue of the use of the specific polymers described above and preferably of a polybrene®, exhibits numerous advantages, inter alia:

the adsorption of the polymer, which is soluble in water, is carried out in aqueous medium from an aqueous solution and not in an organic medium, without preliminary drying of the support, under vacuum, and this contact time is reduced, for example to 1 hour;

the adherence of the polymer to the support, such as silica, is excellent, which dispenses with the stages of crosslinking, carried out at 60° C. (very lengthy), and of fixing via covalent bonding; in addition, the stage in which cationic groups are created is not present either, since the polymer comprises the necessary cationic groups from the start.

In other words, according to the invention, a strongly adherent thin film of polymer is obtained in a single adsorption stage by simple contact, without placing under vacuum, for a period of time, for example, in the region of 1 hour, without preliminary drying and crosslinking, instead of resorting to at least three lengthy and difficult stages, the duration of which can range up to 48 hours, which are energy demanding and which require placing under vacuum and heating.

In addition:

the fixing of the hexacyanoferrate anion by impregnation using an alkali metal hexacyanoferrate solution can be carried out in a simplified way, preferably from pure water.

This is because the number of ionized groups of the film of specific polymer according to the invention does not depend on the pH, which is not the case with the polymers comprising primary, secondary or tertiary amine functional groups (PEI, PVI), the degree of ionization of which depends on the pH;

during the stage of precipitation of the insoluble metal hexacyanoferrate, the formation of complexes with the metal ions, such as the copper ion, in solution is prevented as the polymer employed according to the invention, such as a polybrene®, does not comprise primary, secondary and tertiary amine groups in order to exclude the formation of complexes with copper.

In other words, during this stage of precipitation of the metal hexacyanoferrate, such as copper hexacyanoferrate, there is no formation of complexes between the polymer, such as polybrene®, and the metal ions of the solution, such as the copper ion, since the nitrogen atoms are in the form of quaternary ammoniums devoid of free doublets, which is not the case with the supports, such as silica, treated with other polymers, such as PEI and PVI, or with aminated between the nitrogen atoms and the metal, such as copper, has been observed.

Consequently, according to the invention and because there is no release of metal ions from the material, the lengthy washing operations subsequent to bringing the support into contact with a metal salt are greatly reduced.

In summary, this process, involving specific cationic polymers, is simple, involves known and tested processes, is reliable and is perfectly reproducible, that is to say that it makes possible the preparation of a final product possessing characteristics, a composition and properties which are perfectly determined and which are not subject to random variations.

The preparation process according to the invention differs completely from the processes of the prior art, in particular those involving simple precipitation on a support.

Finally, the invention relates to a process for fixing at least one inorganic contaminant, such as a metal cation, present in a solution by bringing said solution into contact with the composite solid material which fixes inorganic contaminants described above.

The invention will now be described in more detail in what follows, reference being made in particular to the preparation process.

The first stage of this process consists of the impregnation of a solid support with a solution of organic polymer on said solid support.

The solid support is one of those which have already been mentioned above, a preferred support being Lichrospher® 100 silica from Merck®. The polymer is also one of those which were mentioned above, the preferred polymer being a polybrene® (PB), preferably a polybrene® with a molecular mass of 4 000 to 6 000 g/mol supplied by Sigma Aldrich®.

The polymer solution is, according to an advantageous aspect of the invention, a solution in water, for example in demineralized water.

The solution generally has a concentration of 20 to 100 g/l.

Impregnation is carried out by bringing the solid support into contact with the polymer solution for a sufficient period of time, which is, according to the invention, astonishingly short, for example 1 h (instead of 24 to 48 hours with another polymer), in return for which a uniform coating of polymer on the solid is obtained, which coating isolates and protects the solid support, matches the shapes and porosities thereof and retains the specific surface thereof.

The fixing of the polymer to the solid support is essentially governed by an adsorption phenomenon with interactions of electrostatic type; this fixing is, according to the invention, relatively strong without requiring grafting via covalent bonds.

On conclusion of this stage, a solid support coated with a thin film of anion-exchange polymer is thus directly obtained.

The term “film” is understood to mean, as already indicated above, a uniform coating over the entire surface of the solid support which retains substantially the specific surface of the latter.

This film generally has a thickness of 2 to 3 nm.

Rinsing with water and optionally drying under vacuum.

Subsequently, in the following stage, the support coated with a thin film of anion-exchange polymer is impregnated with an aqueous solution of alkali metal hexacyanoferrate(II) or -(III).

This solution is preferably a solution in pure, demineralized water.

The starting alkali metal hexacyanoferrate is preferably chosen from sodium hexacyanoferrate(II), sodium hexacyanoferrate(III), potassium hexacyanoferrate(II) or potassium hexacyanoferrate(III).

The aqueous alkali metal hexacyanoferrate solution employed has a variable concentration, that is to say that the concentration of the alkali metal, in particular potassium or sodium, hexacyanoferrate(II) or -(III) salt is preferably from 1 to 100 g/l, for example 50 g/l.

Furthermore, the aqueous hexacyanoferrate solution employed is prepared so that the ratio by weight of the alkali metal, in particular the potassium of sodium, hexacyanoferrate(II) or -(III) salt to the amount of the impregnation support, essentially composed of the initial solid support, such as silica, is preferably from 5 to 10%.

Impregnation was not carried out at a definite, stable and controlled pH, for example controlled by a buffer. The solution is one in water, preferably pure demineralized water.

The fixing of the anionic part [Fe(CN)₆]⁴⁻ to the cationic groups of the polymer is thus obtained; this fixing takes place by formation of bonds of electrostatic type which are relatively strong depending on the medium and this fixing is generally quantitative, that is to say that all the cationic sites of the polymer react. The fixing therefore does not exhibit any random nature.

The solid support, thus coated with a thin film of anion-exchange polymer to which is fixed an alkali metal hexacyanoferrate, is subsequently subjected to a washing and optionally drying operation.

The aim of the washing operation is to remove the alkali metal hexacyanoferrate salts which have not been fixed to the polymer and the washing operation makes it possible to obtain a composite material which fixes inorganic contaminants in which free nonbonded hexacyanoferrate, which may be released, is no longer present.

Washing is carried out with demineralized water.

The amount of rinsing solution used is variable and can range from 100 to 1 000 ml per gram of product treated.

The following stage is the addition of an aqueous solution of metal salt to the solid support coated with a thin film of an anion-exchange polymer to which is fixed the hexacyanoferrate anion.

The metal salt present in this aqueous solution is a salt, the metal of which corresponds to the insoluble hexacyanoferrate which it is desired to obtain, as has already been indicated above.

This metal is chosen, for example, from copper, cobalt, zinc, cadmium, nickel, iron, and the like. The metal salt will thus, for example, be a nitrate, a sulphate, a chloride or an acetate of one of these metals at a concentration in the aqueous solution preferably of 0.01 to 1 mol/l, more preferably of 0.02 to 0.05 mol/l. Furthermore, the amount of salt used is preferably approximately 0.4 mmol/g of treated support.

The addition of the aqueous solution of the metal salt does not have to be carried out at a definite pH using a buffer solution. The aqueous solution is a solution in pure demineralized water.

Finally, in a last stage, the final material obtained, which thus comprises the solid support coated with a thin film of an anion-exchange polymer to which is fixed an insoluble metal hexacyanoferrate forming a thin layer, is washed.

This final washing stage is carried out in the same way and under the same conditions as the washing stage already described above, using pure demineralized water.

It is preferably compulsory to introduce, into the demineralized water, an alkali metal salt, for example a sodium salt, the anion of which is preferably the same as that of the metal salt employed during the preceding stage, and optionally, in addition, the corresponding acid: use may be made, for example, of sodium nitrate and nitric acid.

This washing operation makes it possible to remove the excess metal salt and to obtain a stable final product with the fully defined composition.

This operation is markedly shorter than in the prior art as the material does not comprise releasable unstable complexes.

Finally, a drying stage is carried out under conditions analogous to those described above.

Generally, drying is continued until the weight of the support remains substantially constant.

The content by weight of inorganic fixing agent, that is to say of insoluble metal hexacyanoferrate, fixed to the anion-exchange polymer is generally from 1 to 10%, for example 3%, with respect to the weight of the inorganic support, such as silica. It has been found, by analysis by neutron activation, that the M₂/Fe atomic ratio can vary from 1 to 5 without the fixing properties, in particular decontamination properties, being affected.

The composite solid material which fixes inorganic contaminants according to the invention can be employed in particular, but not exclusively, in a process for fixing at least one inorganic contaminant, for example a metal cation, present in a solution, in which process said solution is brought into contact with said composite solid material which fixes inorganic contaminants.

The materials according to the invention, because of their excellent properties, such as an excellent exchange capacity, excellent selectivity and a high reaction rate, are particularly suitable for such a use.

This excellent effectiveness is obtained with reduced amounts of inorganic fixing agent, such as insoluble hexacyanoferrate.

Furthermore, the excellent properties of hold and of mechanical stability of the material according to the invention, resulting from its specific structure, make it possible to pack it in a column and to carry out the fixing process continuously, for example in a fluidized bed, which can thus be readily incorporated in an existing plant, for example in a treatment line comprising several stages.

The solutions which can be treated by the process of the invention and with the composite solid material which fixes inorganic contaminants according to the invention are highly varied and can even comprise, for example, corrosive agents, acids, bases or others, because of the excellent chemical stability of the material according to the invention.

The material according to the invention can be used in particular over a very wide pH range. For example, aqueous nitric acid solutions with a concentration ranging, for example, from 0.1 to 3M, acidic or neutral solutions up to a pH of 8, basic solutions, and the like, can be treated. However, there are grounds for optionally adjusting the nature of the solid support to the nature of the solution treated. For example, it is known that silica generally does not withstand a basic pH and that it is then preferable to use a solid support, for example, made of TiO₂; the use of the composite material can then be extended, for example, as far as pH 12.

The inorganic contaminant capable of being fixed in the process according to the invention can be any inorganic contaminant, that is to say, for example, any contaminant resulting from (based on) a metal or an isotope, preferably a radioactive isotope, of this metal, capable of existing in solution.

This contaminant is preferably chosen from anionic complexes, colloids, cations and their mixtures.

It is preferably a contaminant, such as a cation, resulting from an element chosen from Tl, Fe, Cs, Co, Ru, Ag, and the like, and the isotopes, in particular the radioactive isotopes, of these elements, among which may be mentioned ⁵⁸Co, ⁶⁰Co, ⁵⁵⁻⁵⁹Fe, ¹³⁴Cs, ¹³⁷Cs or ^{103,105,105,107}Ru. The metal cation is in particular caesium Cs⁺ or thallium Tl²⁺.

The anionic complex is, for example, RuO₄²⁻.

A preferred use of the material according to the invention is the fixing of caesium, which contributes to a large part of the gamma activity of the liquids from the nuclear industry and which is selectively fixed by hexacyanoferrates.

The concentration of the contaminant (s), such as the cation(s), can vary within wide limits: for example, it can be, for each of these, from 0.1 picogram to 100 mg/l, preferably from 0.01 mg/l to 10 μg/l.

The solution to be treated by the process of the invention is preferably an aqueous solution which can, in addition to the contaminant(s), such as one or more cation(s), to be fixed, comprise other salts in solution, such as NaNO₃ or LiNO₃ or Al(NO₃)₃ or any other soluble alkali metal or alkaline earth metal salt, at a concentration which can reach up to 2 mol/l. The solution can also comprise, as indicated above, acids, bases and even organic compounds.

The solution to be treated can also be a solution in a pure organic solvent, such as ethanol (absolute alcohol), acetone or other organic solvent, in a mixture of these organic solvents, or in a mixture of water and of one or more of these water-miscible organic solvents.

The material according to the invention thus exhibits the advantage of being able to treat solutions which cannot be treated with organic resins.

This solution can consist of a process liquid or of an industrial effluent or other effluents which can result in particular from the nuclear industry and from nuclear plants or from any other activity related to nuclear technology.

Mention may be made, among the various liquids and effluents from the nuclear industry, from nuclear plants and from activities employing radionuclides which can be treated by the process of the invention, of, for example, cooling waters from power stations and all the various effluents coming into contact with radioisotopes, such as all aqueous washing solutions, solutions from the regeneration of resins, and the like.

However, it is obvious that the process according to the invention can also be employed in nonnuclear, industrial or other, fields of activities.

Thus, hexacyanoferrates selectively fix thallium and this property might be taken advantage of in the purification of effluents from cement works for reducing or eliminating the discharges and emissions of this element, which is a virulent poison.

It has been seen that the fixing process according to the invention is preferably carried out continuously, the cation-exchange material according to the invention, preferably in the form of particles, then being packed, for example, in the form of a column, the material preferably forming a fluidized bed, the fluidization of which is provided by the solution to be treated, but the fixing process can also be carried out batchwise, the exchange material and the solution to be treated then being brought into contact, preferably, with stirring. Packing in a column makes it possible to continuously treat large amounts of solution with a high flow rate of these amounts.

The contact time of the solution to be treated with the exchange material can vary and can range from 1 minute to 1 hour for continuous operation and from 10 minutes to 24 hours for batchwise operation.

On conclusion of the fixing process, the fixing (exchanging) composite solid material according to the invention, in which, for example, the metal cations of the hexacyanoferrate have been exchanged by the cations present in the solution, can be stored directly, because its very high mechanical and chemical stabilities and its essentially inorganic nature allow such storage without decomposition of the product occurring, which decomposition results in emanations of hydrogen, or else it can be treated by a process which makes possible conditioning for long-term storage, for example by vitrification.

Vitrification is particularly suitable in the case where the cations fixed are radioisotopes and where the support is silica.

The material according to the invention, by virtue of its specific structure and in contrast to the exchange materials of the prior art based on hexacyanoferrate, can be vitrified without danger as the amounts of inorganic fixing agent are limited and the decontamination in the air without danger.

Finally, it would also be possible to elute the fixed cation, such as a cation of a radioactive element, by selective dissolution of the support, for example using a concentrated sodium hydroxide solution.

The possibility of storing or of treating, for example by vitrification, in a safe and reliable manner, the material according to the invention based on hexacyanoferrate constitutes one of the advantages of the invention and introduces a solution to one of the essential unsolved problems presented by all the exchangers of the prior art, whether, in particular, bulk or composite.

The following examples, given by way of illustration and without limitation, illustrate the preparation of composite exchange materials according to the invention and the results obtained by employing these composite exchange materials in the context of a process for fixing cations according to the invention applied to the fixing of caesium from radioactive effluents.

### EXAMPLE 1

In this example, the synthesis of hexacyanoferrates in a thin layer, the hexacyanoferrates being immobilized on silicas covered with an anion-exchange polymer phase, was carried out, said phase being prepared in a way in accordance with the invention, that is to say from a polybrene®, or not in accordance with the invention, according to the document FR-A-2 765 812.

### EXAMPLE 1A

In this example according to the invention, the anion-exchange polymer is, in accordance with the invention, a polybrene® (PB) having the following structure and characteristics: molar mass 4 000 to 6 000 g/mol.

The procedure is as follows:

A silica support (Silica Gel 100®) supplied by Merck®, having a particle size of 0.063 to 0.200 mm and a porosity of 100 μm, is impregnated with polybrene® (PB) supplied by Sigma Aldrich® by bringing into contact in a column for 1 h in a 15% by weight solution of polymer in demineralized water.

The support, thus coated, is rinsed with demineralized water and drying under vacuum is carried out.

The exchange capacity of the support is measured at pH 7 by adsorbing a 1M NaCl solution and by exchanging it with a 0.5M NaNO₃ solution.

The capacity of the anion exchanger is 0.5 meq per g of silica.

A stage, referred to as “Stage 1”, is subsequently carried out.

Stage 1:

The support, on which the anion exchanger has been adsorbed, is impregnated with a 1M NaCl solution and then the stage referred to as “Stage 2” is carried out.

Stage 2:

The support, coated with a thin film of anion exchanger, is brought into contact with, i.e. impregnated by, a concentrated solution of sodium hexacyanoferrate(II) (50 g/l) in water (no buffer).

The support is subsequently washed with demineralized water.

A copper hexacyanoferrate(II) is formed on the film-coated surface by addition of a 2×10⁻²M aqueous solution of copper(II) nitrate in demineralized water.

Stage 3:

The excess copper hexacyanoferrate is removed by washing with demineralized water with a sodium nitrate solution.

The elemental analysis of the final product obtained is given in Table I below.

### EXAMPLE 1B

In this example according to the invention, the ion-exchange polymer is again, in accordance with the invention, a polybrene® analogous to that of Example 1B.

The procedure is the same as in Example 1A, except that Stage 1 is omitted.

The elemental analysis of the final product obtained is given in Table I.

### EXAMPLE 1C (COMPARATIVE)

In this example, a composite solid material not in accordance with the invention, that is to say according to the procedure of the document FR-A-2 765 812, is prepared, the anion-exchange polymer being prepared from polyethyleneimine (PEI) and not from polybrene®.

The procedure and the product are those of the document FR-A-2 765 812.

The elemental analysis of the final product obtained is also given in Table I below.

TABLE I
Elemental composition of the materials according to the
invention and according to the document FR-A-2 765 812,
based on copper hexacyanoferrate (the percentages are
percentages by weight per g of silica)

| | Method of | Cu | Fe | Cu/Fe |
|---|---|---|---|---|
| Samples | synthesis | (% by weight) | (% by weight) | (at/at) |
| Ex. 1C | Stages 1, 2, 3 | 1.75 | 1.93 | 0.8 |
| (comp.) | | | | |
| Ex. 1A | Stages 1, 2, 3 | 0.97 | 0.78 | 1.15 |
| Ex. 1B | Stages 2, 3 | 0.96 | 0.50 | 1.77 |

The stability of the products according to the invention is demonstrated with regard to Table II in that the products according to the invention based on polybrene® release only a very small amount of iron and virtually no copper during the rinsing operations at the end of the synthesis in comparison with the product prepared according to the document FR-A-2 765 812 with a PEI polymer.

TABLE II
Concentration of copper and of iron released during the
rinsing operations

| | [Cu²⁺] total | |
|---|---|---|
| Products-Samples | (mg/l) | [Fe²⁺] (mg/l) |
| Ex. 1C (comp.) | 12 | 50 |
| Ex. 1A | 8 | 6 |
| Ex. 1B | 1 | 2 |

### EXAMPLE 2

### Caesium Fixing Tests

In this example, a study was carried out on the fixing of radioactive caesium ¹³⁴Cs and ¹³⁷Cs present in various effluents to various products based on hexacyanoferrate, namely:

the composite exchange materials according to the invention prepared in Examples 1A and 1B above;

the material prepared according to the document FR-A-2 765 812 already described above in Example 1C.

The selectivity of caesium for the phases, products or composites is defined by virtue of the constant Kd(1) for distribution between a solid phase and a liquid phase laden with ¹³⁴Cs and ¹³⁷CS.

$$Kd = \frac{amount of Cs * fixed per gram of solid phase}{amount of Cs * remaining per ml of solution} \qquad ( 1 )$$

The greater the value of Kd, the greater the proportion of Cs* retained in the solid phase. A Kd value of greater than 10 000 for contact times of 24 h represents an excellent affinity of caesium for the solid phase.

The radioactive effluents treated are real effluents resulting from the Osiris nuclear reactor of the Nuclear Studies Centre at Saclay, the characteristics of which relating to the radioactivity are mentioned in Table II. The effluents are, on the one hand, the cooling water from the reactor, which is denoted by “OSI” in the table and the pH of which is neutral, and; on the other hand, the solution from rinsing, i.e. from regenerating, the resins, which is denoted by “BF6” in the table and which is composed of a 0.1M nitric acid solution. In order to increase the accuracy of the counts, a tracer, ¹³⁴Cs, was added to the OSI solution.

TABLE III
Radioactivity of the solutions treated in curies per m³

| | ¹³⁴Cs | ¹³⁷Cs |
|---|---|---|
| OSI | 1.02* | 0.36** |
| BF6 | 0.52 | 2.96 |

*Tracer added
**Very variable according to the solutions

The procedure of the tests is as follows:

10 to 20 mg of product are added to 50 ml (cm³) of radioactive solution to be treated and are stirred for a period of time of 10 minutes or of one day according to the tests.

At the end of the chosen period of time, the solution is filtered and its radioactivity is measured by gamma spectrometry and is compared with that of the starting solution.

The values thus obtained make it possible to calculate the ¹³⁷Cs coefficient of distribution representative of the affinity of the product by this element; it is defined by the ratio of the radioactivity fixed per gram of product to the residual radioactivity in solution per cm³ of solution. In other words, the coefficient of distribution Kd of caesium is established according to the relationship (2):

$$Kd = \frac{\begin{matrix}Activity of the blank - \\ Activity of the solution * Volume of filtered solution ( ml )\end{matrix}}{Weight of the sample ( g ) * Activity of the solution} \qquad ( 2 )$$

The greater the value of Kd, the greater the proportion of Cs⁺ retained in the solid phase. A Kd value of greater than 10 000 for contact times of 24 h for solutions at pH=7 represents an excellent affinity of caesium for the solid phase.

The results of the tests carried out for different contact times (10 minutes and 1 day) with different solutions (“OSI” cooling water at a pH in the region of 7 and “BF6” resin aqueous washing solution, that is to say a 0.1M nitric acid solution, pH=1) and with different samples of products based on hexacyanoferrates according to the invention (Ex. 1A and 1B) and according to the document FR-A 2 765 812 (Ex. 1C) are combined in Table IV below:

TABLE IV
Coefficients of distribution Kd (of caesium) with
regard to various products based on hexacyanoferrates
(per g of product)

| | | OSI cooling | | BF6 resin aqueous | |
|---|---|---|---|---|---|
| | | water | | washing solution | |
| | | (pH˜7) | | (pH˜1) | |
| Products- | | Contact time | | | |
| Samples | Protocol used | 10 min | 24 h | 10 min | 24 h |
| Ex. 1C | Stages 1, 2, 3 | >10⁴ | >10⁵ | 4 × 10³ | 3.1 × 10⁴ |
| (comp.) | | | | | |
| Ex. 1A | Stages 2, 3 | 2.6 × 10³ | >10⁵ | 1.3 × 10³ | 6.3 × 10³ |
| Ex. 1B | Stages 1, 2, 3 | 2.5 × 10⁴ | >10⁵ | 2.5 × 10³ | 5 × 10³ |

The results indicated above show that the distribution constants obtained with the products according to the present invention are identical to those of the products of the patent of C. Loos-Neskovic (FR-A-2 765 812).

### EXAMPLE 3

### Column Decontamination Tests

The percolation of a radioactive solution, which is an “OSI” solution as defined above, over the phases synthesized in accordance or not in accordance with the invention, packed in the synthesis column, makes it possible to determine the affinity of caesium for the latter by calculating the coefficient of decontamination.

The decontamination factor is the activity of the solution before passing over the phase to the activity of the solution after passing over the phase (3).

$$Fd = \frac{Activity of the solution ( for example OSI )}{Activity of the fraction recovered} \qquad ( 3 )$$

In practice, in order to withdraw the solution, a pipe comprising a double filter is immersed in 3 l of OSI solution, as described in Table III.

The first filter is a sintered glass filter which retains the particles larger than 20 μm; the following filter is a filter with a lower porosity. A peristaltic pump placed in series withdraws, at a flow rate of 3 ml/min, the solution to a column made of stainless steel (30*5 mm) comprising 1 g of composite. This column is closed at each end by a sintered glass filter and is shielded over its entire height by a lead castle with a thickness of 5 cm. At the column outlet, 50 ml of eluate are collected in an eluate flask every 250 ml of solution treated. The entire assembly is placed in a retaining tank with a volume of 10 ml. The reactivity of the eluates, and of the control, is subsequently measured by gamma spectrometry.

The results are combined in Table V.

TABLE V
Coefficient of decontamination as a function of the
column volume and of the nature of the composite product

| | | | Flow | |
|---|---|---|---|---|
| Products- | | Column | rate | Coefficient of |
| Samples | Solution | volume | ml/min | decontamination |
| Ex. 1C | OSI + ¹³⁴Cs | 3 000 | 3 | >6 000 |
| (comp.) | | | | |
| Ex. 1A | OSI + ¹³⁴Cs | 5 000 | 3 | >6 000 |
| Ex. 1B | OSI + ¹³⁴Cs | 3 000 | 3 | >6 000 |

The values listed in this table are only limit values as the reception limits of the equipment have been reached.

This table shows that the results obtained with the phases synthesized according to the invention are as good as those obtained with the phases based on silica/polyethyleneimine/copper hexacyanoferrate.

1. Composite solid material fixing inorganic contaminants, based on metal hexacyanoferrate, comprising a solid support coated with a film of an anion-exchange polymer to which is fixed an insoluble metal hexacyanoferrate forming a thin layer, characterized in that said polymer is a noncrosslinked polymer, which comprises, as anion-exchange groups, solely quaternary ammonium groups, and in that it does not comprise primary, secondary or tertiary amine groups.

2. Material according to claim 1, in which said polymer is a polybrene®.

3. Material according to claim 1, characterized in that the amount of metal hexacyanoferrate fixed is from 1 to 10% by weight with respect to the weight of the solid support.

4. Material according to claim 1, characterized in that the support is chosen from silica, alumina, titanium oxide, zirconium oxide, diatomaceous earth, zeolites and glasses.

5. Material according to any one of the preceding claims, characterized in that the support is provided in the form of particles, of fibres, of a membrane, of a hollow tube or of a woven or nonwoven fabric.

6. Material according to claim 5, characterized in that the support is provided in the form of particles and has a particle size of 1 to 500 μm.

7. Material according to either one of claims 5 and 6, characterized in that the support has a specific surface of 10 to 500 m²/g.

8. Material according to any one of claims 5 to 7, characterized in that the support has a mean-pore size of 100 to 1 000 Å.

9. Material according to any one of claims 1 to 8, characterized in that said metal hexacyanoferrate is chosen from copper, cobalt, zinc, cadmium, nickel and iron hexacyanoferrates and the mixed hexacyanoferrates relating to these salts.

10. Process for the preparation of the material according to any one of claims 1 to 9, characterized in that it comprises the following stages:
impregnation of a solid support with an aqueous solution of a noncrosslinked anion-exchange polymer comprising, as anion-exchange groups, solely quaternary ammonium groups and not comprising primary, secondary and tertiary amine groups, in order to form a film of said polymer on said solid support;
washing with demineralized water and optionally drying under vacuum;
impregnation of the solid support thus coated with a film of anion-exchange polymer with an aqueous solution of alkali metal hexacyanoferrate;
washing with demineralized water, and optionally drying under vacuum, said solid support coated with a thin film of anion-exchange polymer to which is fixed an alkali metal hexacyanoferrate;
addition of an aqueous solution of a metal salt to said coated solid support, in order to form a composite solid material which fixes inorganic contaminants, comprising the solid support coated with a thin film of anion-exchange polymer to which is fixed an insoluble metal hexacyanoferrate forming a thin layer;
washing with demineralized water, and optionally drying under vacuum.

11. Process according to claim 10, characterized in that the organic polymer solution is a solution in water, for example in demineralized water.

12. Process according to claim 10, characterized in that said alkali metal hexacyanoferrate is chosen from sodium hexacyanoferrate(II), sodium hexacyanoferrate(III), potassium hexacyanoferrate(II) or potassium hexacyanoferrate(III).

13. Process according to claim 10, characterized in that the aqueous alkali metal hexacyanoferrate solution is a solution in pure, demineralized water.

14. Process according to claim 10, characterized in that said metal salt is chosen from copper, cobalt, nickel, cadmium, zinc and iron salts.

15. Process according to claim 10, characterized in that the anion of said metal salt is chosen from nitrates, sulphates, chlorides and acetates.

16. Process according to any one of claims 10 to 15, in which, in the final washing stage, an alkali metal salt, the anion of which is the same as that of the metal salt added to the support during the preceding stage, and, in addition, optionally the corresponding acid, are introduced into the demineralized water.

17. Process according to claim 16, in which, in the final washing stage, sodium nitrate and nitric acid are introduced into the demineralized water.

18. Process for fixing at least one inorganic contaminant present in a solution by bringing said solution into contact with the composite solid material which fixes inorganic contaminants according to any one of claims 1 to 9.

19. Process according to claim 18, characterized in that said solution is an aqueous solution.

20. Process according to claim 18, characterized in that said solution is a process liquid or an industrial effluent.

21. Process according to claim 18, characterized in that said solution is chosen from liquids and effluents resulting from the nuclear industry and from nuclear plants and from activities employing radionuclides.

22. Process according to claim 18, characterized in that the process is carried out continuously.

23. Process according to claim 22, characterized in that the composite solid material which fixes inorganic contaminants is packed in a column.

24. Process according to any one of claims 18 to 23, characterized in that said contaminant is present at a concentration of 0.1 picogram to 100 mg/l.

25. Process according to any one of claims 18 to 24, characterized in that said contaminant results from a metal or from a radioactive isotope of said metal.

26. Process according to claim 25, characterized in that said contaminant is chosen from anionic complexes, colloids and cations.

27. Process according to any one of claims 18 to 26, characterized in that said contaminant is an element chosen from Cs, Co, Ag, Ru, Fe and Tl and the isotopes thereof.
